(19) United States
(12) Patent Application Publication
(10) Pub. No.: US 2004/0247773 A1
(43) Pub. Date: Dec. 9, 2004

(54) Method for making sugared almonds

(76) Inventors: Alain Picquet, Strasbourg (FR); Philippe Zugmeyer, Saverne (FR)

Correspondence Address: FITZPATRICK CELLA HARPER & SCINTO, 30 ROCKEFELLER PLAZA, NEW YORK, NY, 10112, US

(21) Appl. No.: 10/451,803

(22) PCT Filed: Dec. 26, 2001
(86) PCT No.: PCT/FR01/04198

(30) Foreign Application Priority Data
Dec. 26, 2000 (FR) 00/17031

(51) Int. Cl. A23G 3/00

(52) U.S. Cl. 426/660

(57) ABSTRACT

In a method for manufacturing a coated food product or dragée such as an item of confectionery or a garnishing for a pastry or biscuit product, a central core (2) is successively coated with a colored syrup (16), at least one layer of colorless syrup (18), and a gloss coating syrup (20).

The invention relates to the manufacture of confectionery items and the like comprising a central core carrying a coating, sometimes known as dragées and referred to hereinafter as coated comestible items, intended for use as confectionery or garnishing items, particularly for cakes and pastries or biscuits.

It is known that, during their manufacture, chocolate covered coated comestible items undergo several applications of a sugared and colored solution called syrup before being coated with a gloss coating syrup. In certain cases, for example when the coated comestible item is incorporated onto the external face of a product that is intended to be iced, the condensation that forms on the surface of the coated comestible item after the package is opened often causes the instant discoloration of the coated comestible items on the fingers of the consumer when the product is handled. However this is a disadvantage that the consumer generally does not accept.

An aim of the invention is to provide a method for manufacturing coated comestible items that limits the risk of discoloration of the coated comestible items when the product is handled and consumed.

In order to achieve this aim, the invention provides a method for manufacturing coated comestible items in which a central core is successively coated with the following substances:

a colored syrup

at least one layer of colorless syrup, and

a gloss coating syrup.

Thus, the colorless syrup applied in one or several layers after the application of the colored syrup and before the application of the gloss coating syrup considerably reduces the risk of discoloration when handled, especially during condensation if the coated comestible item is initially iced.

The invention also provides a method for manufacturing coated comestible items in which a central core is successively coated with the following substances:

a colored syrup, and

at least two layers of colorless syrup.

The method according to the invention may also comprise at least one of the following characteristics:

one of the two layers of colorless syrup is a layer of gloss coating syrup

the gloss coating syrup contains gum

the number of layers of colorless syrup is between 1 and 8

the, or at least one of the, layers of colorless syrup comprises a polysaccharide

the central core contains chocolate, and

the central core is chosen from the group comprising: a piece of fruit, which may be dried or crystallised, a souffle item of food, a jellified composition and an extruded composition.

The invention also provides a coated comestible item comprising a central core and, covering this element, the following successive layers:

a colored syrup, and

at least two layers of colorless syrup.

The invention also provides a coated comestible item comprising a central core and, covering this element, the following successive layers:

a colored syrup

at least one layer of colorless syrup, and

a gloss coating syrup.

The coated comestible item according to the invention may comprise at least one of the following characteristics:

the coated comestible item is a garnishing item intended for a food preparation

the coated comestible item is frozen or intended to be frozen, and

the coated comestible item is intended to be cooked.

The invention also provides for a food preparation comprising a coated comestible item according to the invention.

For example, it could be a confectionery, a cake or pastry or a biscuit. And it could be a frozen preparation.

Other characteristics and advantages of the invention will become clear in the following description of a preferred embodiment of the invention given as an example and in nowise limitative. In the appended drawings:

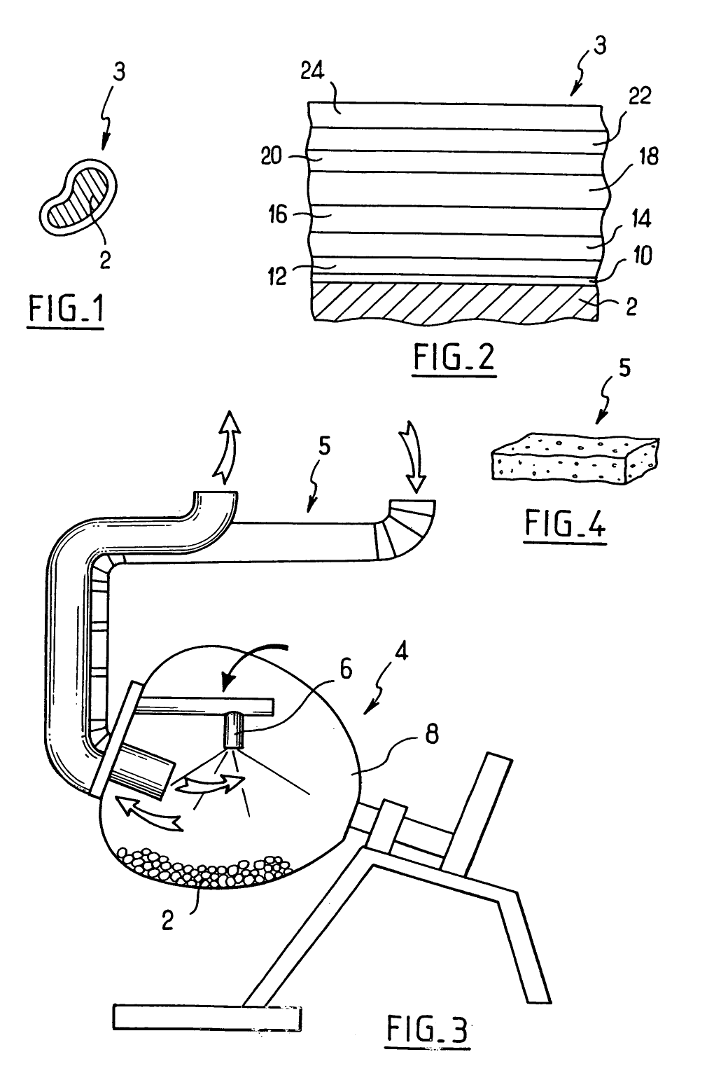

FIG. 1 is a schematic cross sectional view of a coated comestible item according to the invention.

FIG. 2 is a partial cross sectional view of the coated comestible item in FIG. 1 showing the structure of its surface.

FIG. 3 is a schematic cross sectional view of a turbine for applying the different layers onto the coated comestible item, and

FIG. 4 is a schematic perspective view of a food preparation incorporating the coated comestible item according to the invention.

In the present embodiment of the method according to the invention, the first stage consists in moulding a center 2 in chocolate, in reference to FIG. 1. The composition of the center is of a conventional type and will not be detailed further.

The centers 2 are then placed in a turbine 4 shown in FIG. 3 in order to receive different layers intended to coat the center 2. This turbine comprises means for ventilation 5 and a nozzle 6 for spraying onto the centers 2 the different layers that cover said centers. This type of turbine is known per se and will not be described further. The turbine comprises a moving vessel 8 that rotates around its axis during the coating, this axis being inclined in relation to the vertical.

The different layers are applied onto the centers in the following manner.

Firstly, a mixture 10, based on icing sugar and titanium dioxide (TiO₂) intended to make the centers white is applied onto the centers.

Then, a layer 12 of cold syrup, intended to provide suppleness to the surface of the coated comestible items is applied onto the centers. This syrup comprises, in a conventional manner, water and a polysaccharide.

Then, a layer 14 of syrup without colorant, also comprising water and a polysaccharide, is applied over this layer.

The process is then continued by applying onto the coated comestible items at least one layer 16 of syrup with colorant, intended to provide a certain color to the coated comestible item once it has been completed.

According to the invention, several layers 18 of a syrup without colorant, intended to prevent the discoloration of the coated comestible item in the hands of the consumer, are then applied. In this particular case, this syrup is a mixture comprising 70 to 80% saccharose, between 1 and 9% water and between 1 and 5% glucose with a dextrose equivalent (DE) of between 35 and 46. The number of layers of colorless syrup applied at this stage varies between 1 and 8, depending on the composition of the syrup used and the degree of protection desired. It should be noted that beyond 8 layers, a loss of color intensity in the coated comestible item may occur.

The syrup is applied in the turbine at a temperature preferably between 35 and 55° C., and advantageously around 45° C. The application time in the turbine varies between 7 and 10 minutes depending on the composition of the layer, the temperature of the drying air (which is itself at a temperature of between 15 and 25° C.) and the air speed (preferably between 5 and 10 metres per second).

After the application of the colorless syrup, a gloss coating syrup 20, known per se, and which comprises water, sugar, glucose and carob bean gum, which imparts elasticity to the surface of the product, is applied.

The next stage consists in applying, onto the coated comestible item, a gloss coating wax 22 comprising, in particular, caranda in this particular case.

The final layer 24 applied is a gloss wax.

The coated comestible item 3 is obtained in this way.

This method may be used for various types of coated comestible items. Thus, the center, instead of being made out of chocolate could comprise or be made up of a piece of dried fruit (such as a nut: almond, hazelnut, peanut, etc.). It could also be an extruded product, a blown product (especially a cereal), or a jellified product.

The colorless syrups used may be composed more generally of glucose, sucrose or maltodextrins and, in a general manner, a polysaccharide of any type.

The coated comestible items obtained in this way may be used as a garnish for any confectionery or cake or pastry product (cakes, biscuits, etc.) 5 as shown in FIG. 4, with a low moisture level, whether frozen or not.

The coated comestible items obtained in this way have the same visual characteristics and shelf life as conventional coated comestible items. However, thanks to the method, their discoloration in the hands of the consumer takes between 2 and 10 time longer than conventional coated comestible items, as a function of the number of applications and the composition of the colorless syrup used. Thanks to the coated comestible items according to the convention, any phenomenon of discoloration of the coated comestible items in the hands of the consumer is delayed or even eliminated given the average handling time before consumption, even if the coated comestible item is consumed in an iced condition.

1-16. (Cancelled)

17. A method for manufacturing coated comestible items, wherein a central core is successively coated with the following substances:
(i) a colored syrup,
(ii) at least one layer of colorless syrup, and
(iii) a gloss coating syrup.

18. The method according to claim 17, wherein the gloss coating syrup contains gum.

19. The method according to claim 17, wherein the number of layers of colorless syrup is between 1 and 8.

20. The method according to claim 17, wherein at least one of the layers of colorless syrup comprises a polysaccharide.

21. The method according to claim 17, wherein the central core contains chocolate.

22. The method according to claim 17, wherein the central core is chosen from the group comprising: a piece of fruit, which may be dried or crystallised, a blown food item, a jellified composition and an extruded composition.

23. A method for manufacturing coated comestible items, wherein a central core is successively coated with the following substances:
(i) a colored syrup; and
(ii) at least two coats of colorless syrup.

24. The method according to claim 23, wherein one of the two layers of colorless syrup is a layer of gloss coating syrup.

25. The method according to claim 24, wherein the gloss coating syrup contains gum.

26. The method according to claim 23, wherein the number of layers of colorless syrup is between 1 and 8.

27. The method according to claim 23, wherein at least one of the layers of colorless syrup comprises a polysaccharide.

28. The method according to claim 23, wherein the central core contains chocolate.

29. The method according to claim 23, wherein the central core is chosen from the group comprising: a piece of fruit, which may be dried or crystallised, a blown food item, a jellified composition and an extruded composition.

30. A coated comestible item, comprising a central core and, covering this core, the following successive layers:
a) a colored syrup, at least one layer of colorless syrup, and a gloss coating syrup; or:
b) a colored syrup and at least two coats of colorless syrup.

31. The coated comestible item according to claim 30 wherein the coated comestible item is a garnishing item intended for a food preparation.

32. The coated comestible item according to claim 30 wherein the coated comestible item is frozen or intended to be frozen.

33. The coated comestible item according to claim 30, wherein the coated comestible item is intended to be cooked.

34. A food preparation which comprises a coated comestible item comprising a central core and, covering this core, the following successive layers:
a) a colored syrup, at least one layer of colorless syrup, and a gloss coating syrup; or:
b) a colored syrup and at least two coats of colorless syrup.

35. A food preparation according to claim 34, consisting of a confectionery item, a cake or pastry or a biscuit.

36. A food preparation according to claim 34, wherein it is frozen.
